(19) United States
(12) Patent Application Publication
(10) Pub. No.: US 2017/0270551 A1
(43) Pub. Date: Sep. 21, 2017

(54) Method and system for distributing targeted messages on social media

(71) Applicant: Joe Zheng, Cupertino, CA (US)

(72) Inventors: Haifeng Chen, Hayward, CA (US); Joe Zheng, Cupertino, CA (US)

(21) Appl. No.: 15/073,344

(22) Filed: Mar. 17, 2016

(51) Int. Cl. G06Q 30/02; H04L 29/08; G06Q 50/00; H04L 12/58

(52) U.S. Cl. CPC G06Q 30/0214; H04L 51/32; H04L 51/10; H04L 67/26; G06Q 50/01; G06Q 30/0267

(57) ABSTRACT

Posts or messages exchanges via data communication between client devices aw well as a client device and a server device over the Internet are described. According to one aspect of the present invention, a post is made to a targeted recipient who is encouraged to watch, read or listen to (collectively referred to as “access”) the post and compensated for accessing the post. Depending on situation, the post can be made directly to the recipient via messaging or published to a whitewall for access by one or a group of selected contacts.

### BACKGROUND OF THE INVENTION

Field of the Invention

The present invention is generally related to the area of data communication between clients as well as a client and a server over the Internet. Particularly, the present invention is related to techniques for distributing certain messages on a digital social media (e.g., WeChat and Facebook), where viewing or listening to a message by a user being targeted is encouraged and subsequently compensated. Depending on implementation, a message (e.g., text, photo, audio or video) is prepared and distributed by a distributor who may be an individual user or a business, where the distributor desires to have the message or certain links therein accessed by a recipient. To encourage or induce the recipient to access the message, the distributor sets a pay rate for accessing the message, the recipient is compensated for having accessed the message. Depending on the constraints imposed by a recipient, promotional messages such as advertisements can be delivered efficiently and usefully, thus effectively catching the eyes of the recipient expressing an interest in goods/services in the messages and reaching a result that a traditional advertising campaign would never match.

Description of the Related Art

Social media takes on many different forms including blogs, business networks, enterprise social networks, forums, microblogs, photo sharing, review, social bookmarking, social gaming, social networks, video sharing, virtual worlds and etc. Technically, social media introduces substantial and pervasive changes to communication between businesses, organizations, communities, and individuals. These changes are the focus of the emerging field of technoself studies. Social media differs from traditional or industrial media in many ways, including quality, reach, frequency, usability, immediacy, and permanence. A social media operates in a dialogic transmission system (many sources to many receivers). This is in contrast to traditional media that operates under a monologic transmission model (one source to many receivers).

There are numerous social media websites or platforms, the most popular ones may be WeChat originated from China and Facebook originated from US. It is reported that WeChat has over 650 Million activate users in China and 70 Million users outside of China while Facebook has well over 1.5 Billion users worldwide. There are not only enormous users interacting with each other on such a social media platform each day, but the platform also provides a history of activities by each of the users. As such, a statistic analysis may be performed to derive what kind of interests a user may have and what the user may be up to.

One of the most popular elements of WeChat is the “Moments” function, which is utilized in a similar fashion as Facebook's NewsFeed. Users are able to share articles, links, photographs, audios, videos and music among other things with their friends or contacts, who in turn are able to “Like” and comment on the posts. A staggering 76.4% of users routinely use “Moments” to see what their friends are up to or to post content themselves. It is reported that over 3 billion items of content are shared per day through “Moments”. This is an intriguing statistic because whereas Facebook's “NewsFeed” is the main landing page of the website, “Moments” seems to be designed to be a secondary aspect to WeChat's core messaging service. To take that a step further, in actuality, WeChat has found that a much higher percentage of users partake in content sharing or consumption on Moments than messaging their friends.

Many businesses have already started to utilize such a social media platform to advertise their products or services. Besides signing up as a user to publish various articles or explicit advertisements on a social media, a business also interacts with other users to draw their attention to a product or a service offered by the business. In addition, various tools or applications (e.g., Apps) are introduced for individual users to post their moments or newsfeed on a social media platform, all with substantially similar purpose to draw the users to their websites or attentions to their goods and services.

Without looking at obvious advertisements on a social media, many users even skip many posts that appear unrelated to their interests. With the volumes published each day, it takes too much time to go through the advertisements or posts even by their loved ones. In reality, not many users are willing to do so even if some of the advertisements or posts appear interesting. However, the situation would be different if a user is promised to be compensated for viewing some advertisements relevant to his/her interests. Thus, there is a need for a technology behind a mechanism that encourages a recipient to access a publication on a social media for compensation. Other needs shall become apparent upon examining the following detailed description of the present invention.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to data communication between client devices and a client device and a server device over the Internet. According to one aspect of the present invention, a post is made to a targeted recipient who is encouraged to watch, read or listen to (collectively referred to as “access”) the post and compensated for accessing the post. Depending on situation, the post can be made directly to the recipient via messaging or published to a whitewall for access by one or a group of selected contacts.

According to another aspect of the present invention, a special set of code is distributed manually, automatically or randomly across the content in a post or message. A reader is instructed to collect the code while going through the message. Upon reporting the codes to a sender of the message, the reader is compensated for what is promised by the sender or an original author of the message when the set of code is confirmed, including the order thereof.

According to still another aspect of the present invention, a message is embedded with explicit contents or links. A reader is instructed to access the contents or activate the links to explore the details thereof and subsequently compensated. Depending on application, the explicit contents may be related to a slogan, an article, a commercial message, an advertisement or others. The links are hyperlinks to separate displays showing details of a slogan, an article, a commercial message, an advertisement or others in any formats (e.g., audio, video, text, or photos).

According to still another aspect of the present invention, when such a message is forwarded by a first user to a second user, those explicit contents or links tailored for the first user are replaced by newly allocated explicit contents or links for the second user to induce the second user to access one or more of the newly allocated explicit contents or links.

According to yet another aspect of the present invention, compensations for accessing a post on a social media may come in different forms that include, but may not be limited to, cashes, points, rewards, electronic payments, discounts, opportunities and other incentives. A preferable settlement is via an account privately held by a reader, where the account may be kept on a mobile device associated with the user or on a designated server privately accessible by the user. In one case, the settlement or payment in such an account can be used by the user to settle an obligation by or a charge to the user.

The present invention may be implemented in software or in a combination of software and hardware, and practiced as a system, a process, or a method. According to one embodiment, the present invention is a method for accessing a post on a social media platform, the method comprises: providing a social media platform supporting a post made by a first user using a first mobile device to at least a second user using a second mobile device, wherein the post includes a message embedded with at least a set of electronic code; causing the second mobile device to display the code when the message is being accessed by the second user on the second mobile device; receiving the code from the second mobile device after the second user uncovers the code from the message while accessing the message; forwarding the code reported by the second user to the first mobile device for verification by the first user; and settling a reward to an account maintained by the second user in the second mobile device when the first user confirms the code. The post includes at least one of a text, a photo, an audio clip, a video clip and a hyperlink.

According to another embodiment, the present invention is a method for accessing a post on a social media platform, the method comprises: providing a social media platform supporting a post published by a first user using a first mobile device to a sharing space formed by a group of selected contacts of at least a second user using a second mobile device; verifying whether the second user has opted in receiving advertisements matching interests expressed by the second user; inserting one or more allocated advertisements in the post; pushing the post to the second mobile device, wherein the post includes a message embedded with the one or more allocated advertisements; and settling a reward to an account maintained by the second user in the second mobile device when the message is accessed by the second user.

According to yet another embodiment, the present invention is a server for accessing a post on a social media, the server comprises: a network interface to facilitate the server to communicate with a plurality of mobile devices, a memory space for storing a server module; a processor, coupled to the memory space, executing the server module to cause the server to perform operations of: receiving a post made by a first user using a first mobile device for at least a second user using a second mobile device, wherein the post includes a message embedded with at least a set of electronic code; causing the second mobile device to display the code when the message is being accessed by the second user on the second mobile device; receiving the code from the second mobile device after the second user uncovers the code from the message while accessing the message; forwarding the code reported by the second user to the first mobile device for verification by the first user; and settling a reward to an account maintained by the second user in the second mobile device when the first user confirms the code.

One of the objects, features, and advantages of the present invention is to encourage a post to be accessed by a recipient by rewarding a type of incentive to the recipient, especially on a social media.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows a basic system configuration in which the present invention may be practiced in accordance with one embodiment thereof;

FIG. 1B, it illustrates an internal functional block diagram of a mobile device that may be used as a client device in FIG. 1A;

FIG. 1C illustrates an internal functional block diagram of an exemplary mobile device that may be used as a client in FIG. 1A;

FIG. 2A shows a logic relationship between a client and a server, where the client represents one of many clients that are intended to communicate with the server;

FIG. 2B.1 shows a set of exemplary displays that may result from the client module being executed in the mobile device;

FIG. 2B.2 shows an example of providing three windows (slot A, B and C) to show ads related to food and drinks to a user;

FIG. 2C shows that an ad publisher may cooperate with a content publisher to place the relevant ads in lieu of the ads selected or placed by the content publisher;

FIG. 2D shows an example in which a user in US is accessing a website operated by a Chinese content provider;

FIG. 3A shows a flowchart or process of reaching an agreement with a user to get compensated for viewing one or more ads from one or advertisers;

FIG. 3B shows an example of allocating relevant ads for a user using a device (not shown), where it is assumed that the user has provided a list of his preferences (e.g., discounts/promotions from all local stores near his location, energy drinks and featured products/services in his area) in addition to his desire of buying a flat smart TV in size of 40-45 inches in the next one or two weeks;

FIG. 3C shows two examples of displaying the ads on a mobile device the user is using;

FIG. 3D shows how to report an activity of viewing an ad according to a pre-set of criteria;

FIG. 3E shows an exemplary webpage on a social network to show a forwarded ad either on a personal page (a whitewall) or to an appointed contact;

FIG. 3F shows an exemplary webpage on a social network, where a user maintains his own pages, one of which shows a list of contacts established by the user;

FIG. 4A shows a functional block diagram of a server machine or server in which a server module resides in a memory space and is executable by one or more processors;

FIG. 4B shows a flowchart or process of forming a queue of ads to be shown to a user;

FIG. 4C shows an example of ad opportunity before an application is fully launched;

FIG. 4D shows an example of lined-up ads for showing when an opportunity presents; and

FIG. 4E shows a display of a group space named “Discussion Group” formed by a group of 3 users, user A, user B and user C, presumably known to each other.

### DETAILED DESCRIPTION OF THE PREFERRED EMBODIMENTS

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

The present invention pertains to a system, a method, a platform and an application each of which is invented, uniquely designed, implemented or configured to cause a server device to determine what is the most relevant information a subscriber is interested in viewing at a cost most effective to the publisher/advertiser of the information and a payment most appealing to the user. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

One of the benefits, advantages and objectives in one embodiment of the present invention is to allow a publisher and a user to reach a mutual agreement for the publisher to deliver what is interesting to the user, where the user is compensated for accessing a publication from the publisher. As used herein, a publisher is a user or party that posts a message on a social media. The recipients of the message are not random to the publisher but have authorized or opted in the delivery of the message to them. Depending on the nature of the message, a publisher or a recipient may be a registered user of a social media or a contact of another user. In the following, unless explicitly stated, a user who posts a message is referred to as a publisher while a user receives the message is referred to as a recipient. To facilitate the description of the present invention, an ad and a message are interchangeably used herein. Those skilled in the art well understand that a message can be in any form (such as a text, a graph, a photo, a hyperlink, an audio, a video and etc) and does not have to be an ad. Essentially, a message is a publication in any form released or posted by a user to a social media platform and to be accessed by a targeted user or a selected group of users. In addition, wherever there is a description of a recipient or a user accessing a message, it means the user reads, watches, views or listens to a message depending on the nature of a message.

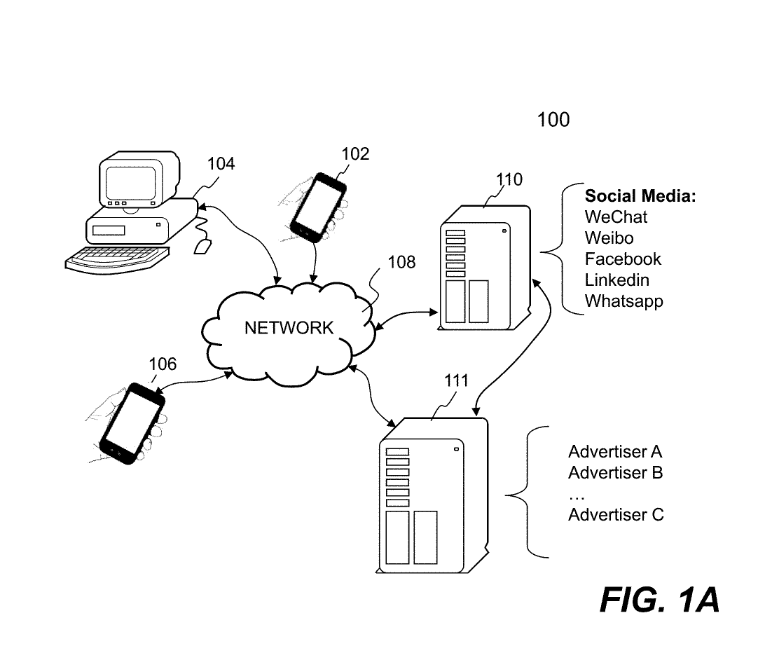

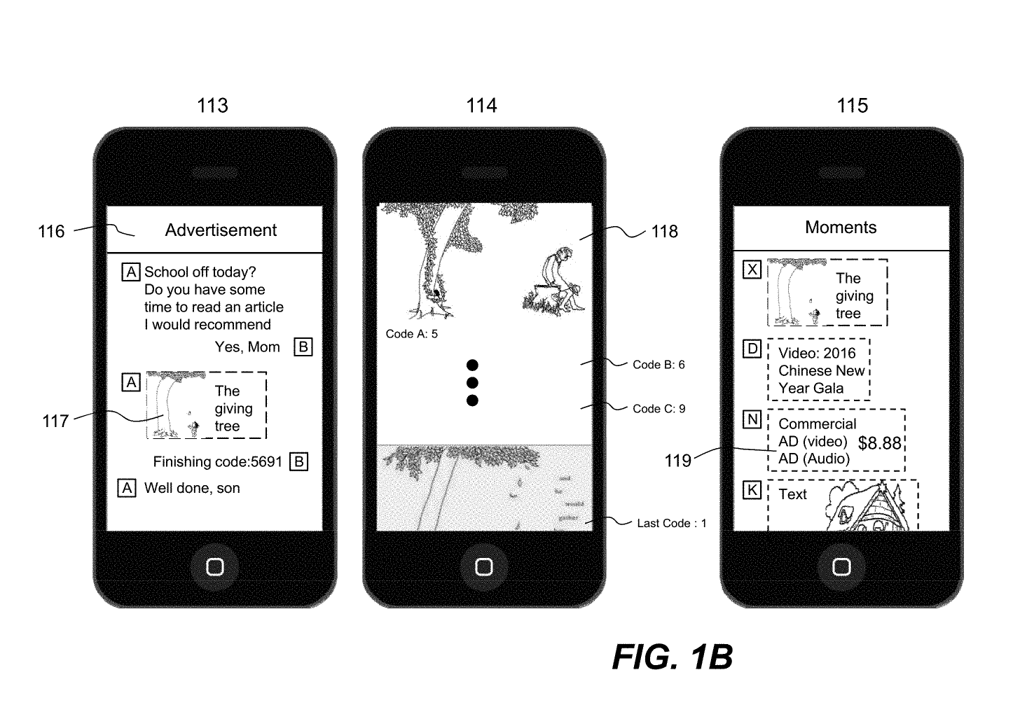

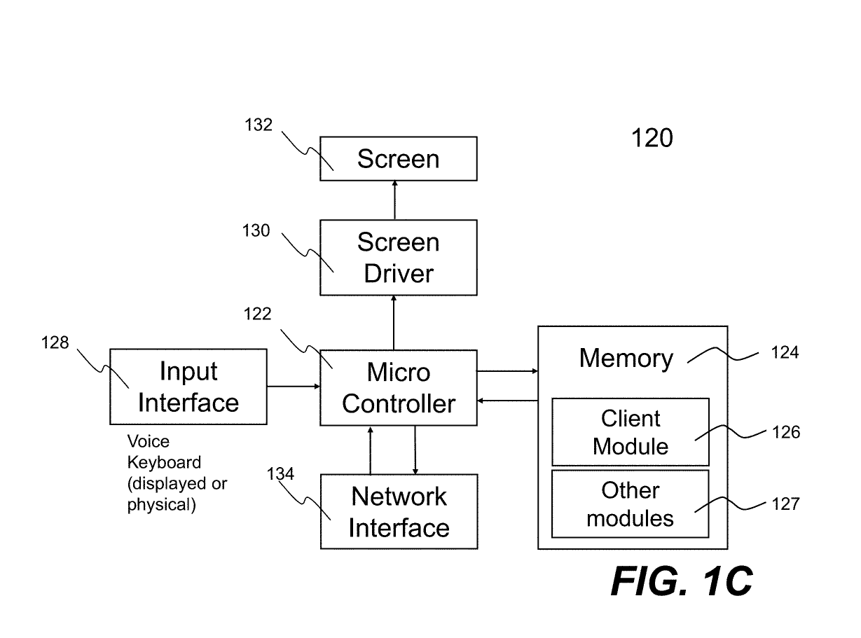

Referring now to the drawings, in which like numerals refer to like parts throughout the several views. FIG. 1A shows a basic system configuration 100 in which the present invention may be practiced in accordance with one embodiment thereof. FIG. 1A shows that there are three representative computing devices 102, 104 and 106, where the device 102 or 106 is meant to be a mobile device (e.g., a wearable device, a smart phone, a tablet or a laptop) while the device 104 is meant to represent a stationary device (e.g., a desktop computer). Each of the devices 102, 104 and 106 is loaded with one or more programs, applications or client modules. In particular, Each of the devices 102, 104 and 106 is associated with a user, and is preferably to have a touch-screen display, as most of the mobile devices do. Although other man-machine interfaces are possible, a touch-screen display provides the convenience for a user to interact with a presence of a message. It should be noted the presence of a message herein means that there is an indication of the message and requires an interaction of the user with it to access it. For example, an elongated ad banner or a hypertext with link is considered a presence of an ad. To view the details of the ad, a viewer must interact with it, for example, after a predefined time or a click on it brings up another view of the ad (e.g., a product description with photos and a video or a website showing a product). In the context of the present invention, the user is only compensated when actually having accessed a published message or ad.

As shown in FIG. 1A, a server device 110 is provided to support a social media platform. The server device or server 110 represents a cluster of servers configured to support millions of users interacting with their contacts on the platform. In the case of the WeChat platform, the server 110 allows a registered user to exchange messages with one or several of his contacts, establish a relationship with a new user, access messages posted by his contacts and post a message on Moments.

According to one embodiment, a server device 111 is provided to distribute one or more ads to its registered users, where the registered users have opted in to receive the ads and are compensated accordingly for accessing some or all of the received ads. In operation, the server device 111 maintains a plurality of accounts, each corresponding to a subscriber, an audience member, a listener, a viewer, a user of mobile device, an advertisee (a person to receive an ad) or a user who has expressed his particular interests to view related ads for pay. For simplicity, server device and server are interchangeably used hereinafter, so are client and client device. Accordingly, FIG. 1A shows a server 110 or 111 executing a server module is in data communication with a plurality of clients, each of the clients executing a client module, where the server module or the client module implements one or more embodiments of the present invention.

Referring now to FIG. 1B, it shows three exemplary displays 113, 114 and 115, each showing a situation in which a targeted message or an explicit ad is delivered or can be accessed. The display 113 shows two users A and B are exchanging messages. At top of the display 113, there is an explicit ad 116 or an access to an ad category. When it is an explicit ad (e.g., showing a lunch deal near lunch time), a click thereon brings another display to show the detail of the ad (e.g., 30% off on a lunch combo at McDonald's near user A, assuming the display 113 is from a mobile device being used by user A). This ad can be distributed by the server 110, sometimes depending on an interest of user A or what the messages may be related to. As will be further described below, one of the important features, advantages and objects in the present invention is that the ad is selected per the user and delivered based an expressed interest from the user, and the user earns something (e.g., money, points, opportunity, awards and etc., herein collectively as “rewards”) for accessing the ad.

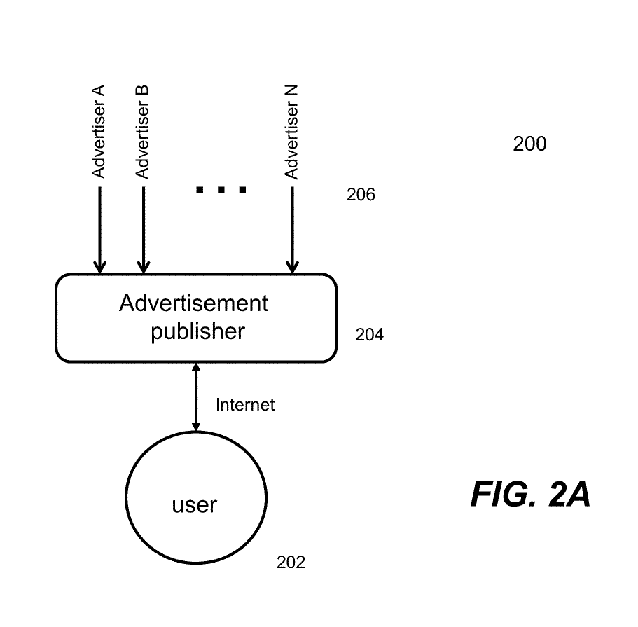

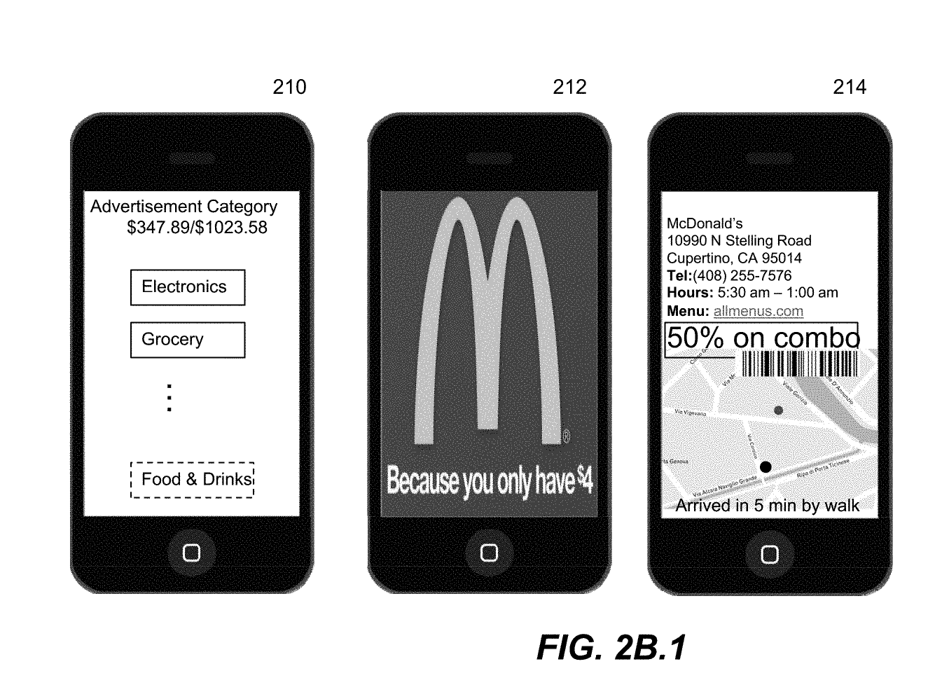

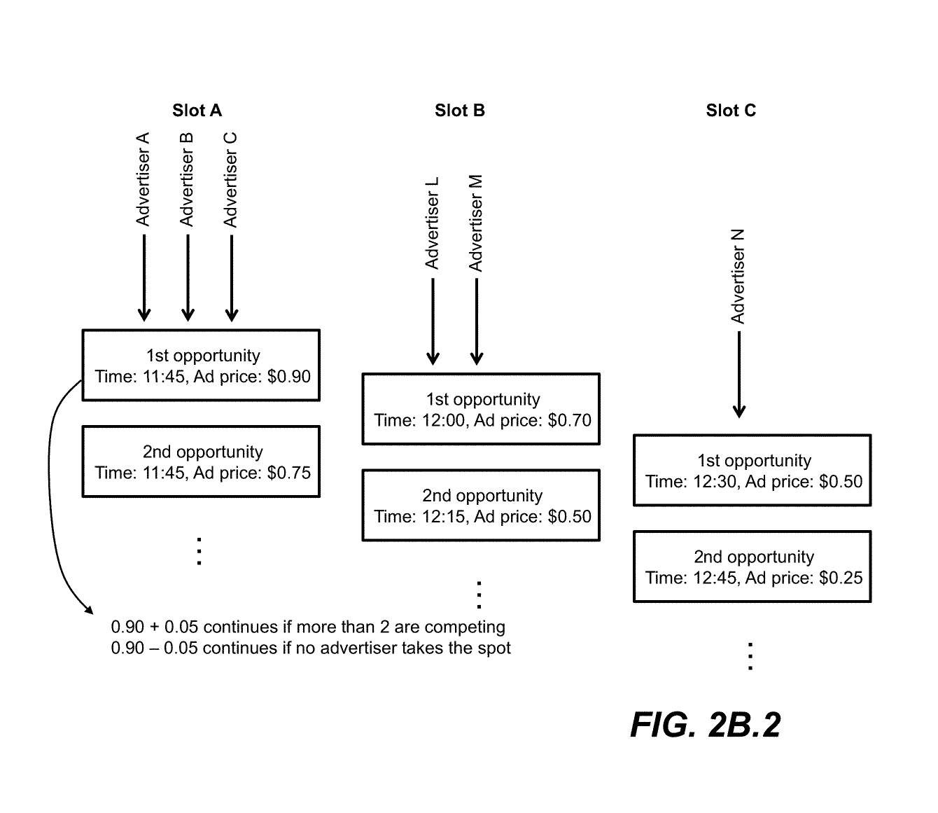

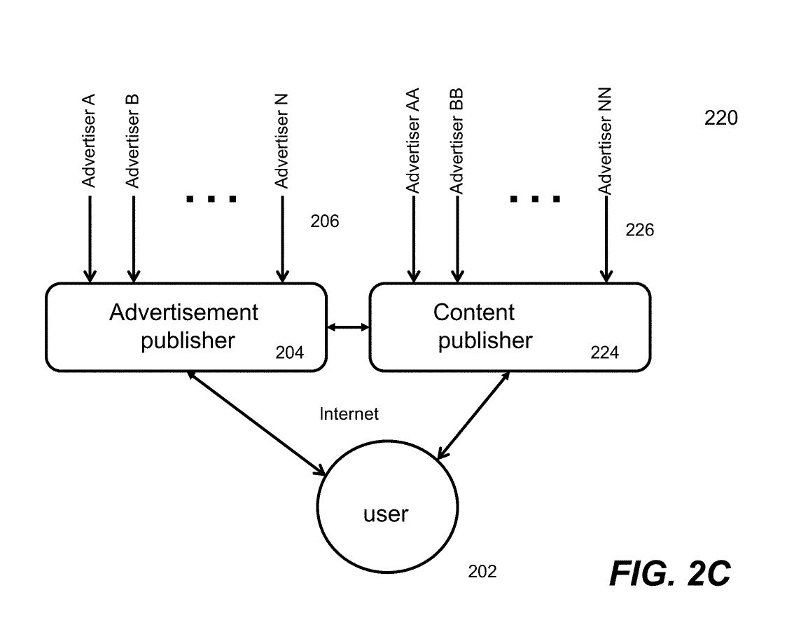

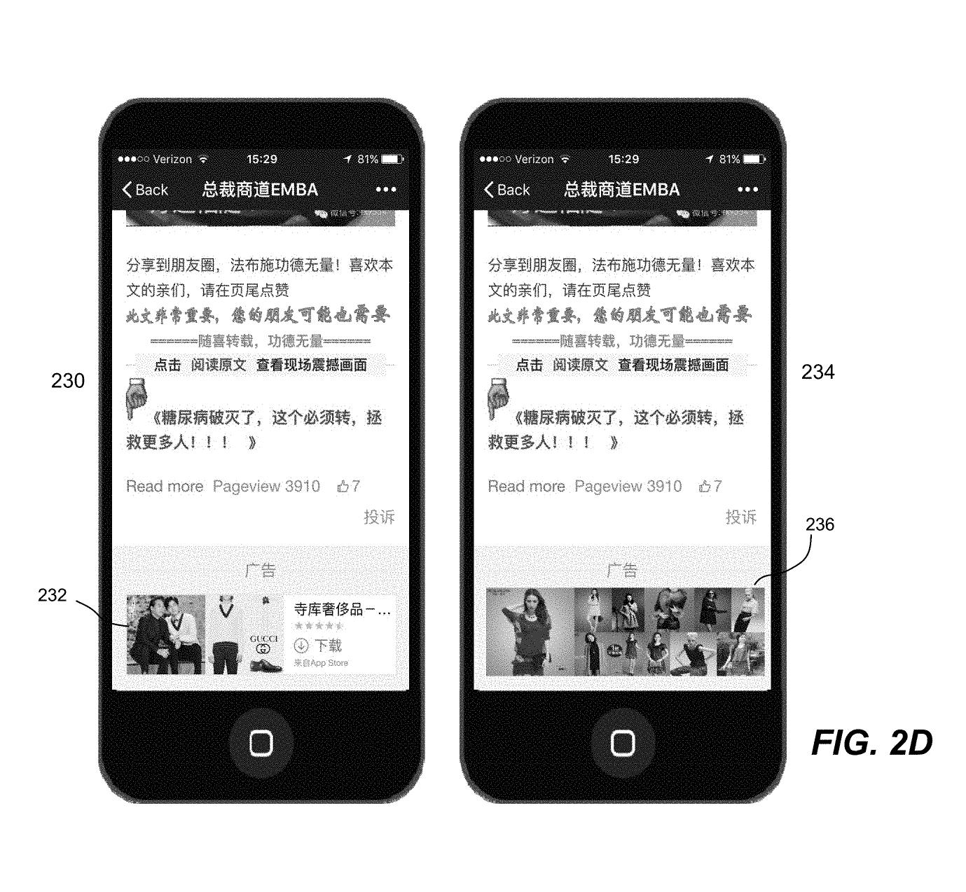

An ad category is where there is a collection of ads that may be categorized for a user to browse. In the context of the present invention, the ads are personally allocated for the user based on his expressed interests and delivered to his device at the time his device is online. These ads are periodically updated and queued. The user is compensated for accessing some or all of the ads. When the top of the display 113 shows an ad category, the user may click on it anytime to earn some rewards by browsing the ads listed in the ad category. FIG. 2B.1 shows one exemplary display of an ad category, the detail of which is to be described below when appropriate.

The display 113 further shows that user A sends a targeted message (icon) 117 to user B, where a targeted message is a personalized message prepared by user A for user B. In general, such a message could be ignored or glanced at by user B. To ensure that user B does read the message carefully and completely, user A may embed some symbols or codes that are distributed randomly or manually in the message 117. The display 114 shows the content 118 of the message 117 when user B opens (e.g., by clicking the message 117). As user B reads through the message by scrolling up or down the pages, he notices and then collects the codes sequentially. At the end of the message, user B is supposed to have collected all of the codes and then reports them to user A. When the codes are verified by user A who is convinced that user B has read through the message, user B is compensated by a reward. According to one embodiment similar to red envelope distribution on WeChat, user B maintains an electronic wallet in his mobile device, a certain amount of money predetermined by user A to reward user B is transferred to the wallet when user B finishes reading through the targeted message. The example in the displays 113 and 114 show collectively that a mother encourages her son to read an article selected by the mother and rewards the son after the son finishes the reading by reporting back the codes. Given this example, those skilled in the art can generate numerous cases in which recipients are encouraged to read distributed articles for rewards. One of the cases may be that an advertiser encourages a user to access its ad by embedding some codes in the ad, where the user gets an reward after collecting the codes. Another of the cases may be that a newspaper publisher encourages a reader to read its online published newspaper by embedding some codes on each of the pages, where the reader gets an reward after collecting the codes from each of the pages in the newspaper.

The display 115 shows an exemplary moments of user A on WeChat. Similar to a whitewall or NewsFeed on Facebook, The moments allows contacts of user A to share with user A what they are up to or they believe interesting. As an example, the moments in the display 115 shows that contacts X, D, N, K are sharing a photo book (e.g., the giving tree), a video performance (e.g., 2016 Chinese New Year Gala), a commercial-oriented audio or video clip and a text. Many of the these shared messages are not original. They are forwarded or shared from others, namely from contacts of contacts. In reality, the more contacts the user has, the more sharing or publications there are on the moments. It is very unlikely that the user would access all of the publications as some of them could be extremely long in time. For example, the video performance of 2016 Chinese New Year Gala may last more than four hours. To encourage the user to access what a publisher thinks important, the publisher may indicate or show a corresponding reward if a reader access it. A message 118 shared by contact N is originally prepared by an advertiser. Because there is a pay for accessing the message, the message 118 may have been shared or published many times on the moments of many users.

Referring now to FIG. 1C, it illustrates an internal functional block diagram 120 of an exemplary mobile device that may be used as a client in FIG. 1A. The mobile device includes a microprocessor or microcontroller 122, a memory space 124 (e.g., RAM or flash memory) in which there is a client module 126, an input interface, a screen driver 130 to drive a display screen 132 and a network interface 134. The client module 126 may be implemented as an application implementing one embodiment of the present invention, and downloadable over a network from a library (e.g., Apple Store) or a designated server.

The input interface 128 includes one or more input mechanisms. A user may use an input mechanism to interact with the device 120 by entering a command to the microcontroller 122. Examples of the input mechanisms include a microphone or mic to receive an audio command and a keyboard (e.g., a displayed soft keyboard) to receive a click or texture command. Another example of an input mechanism is a camera provided to capture a photo or video, where the data for the photo or video is stored in the device for immediate or subsequent use with other module(s) or application(s) 127. The driver 130, coupled to the microcontroller 122, is provided to take instructions therefrom to drive the display screen 132. In one embodiment, the driver 130 is caused to drive the display screen 132 to display an image or images (e.g., an ad banner) or play back a video (e.g., an ad video). The network interface 134 is provided to allow the device 120 to communicate with other devices via a designated medium (e.g., a data network).

According to one implementation, the client module 126 is loaded in the memory 124 and executed by the controller 122 to receive an ad and determine how the user views the displayed ad. As will be further described below, the ad may be simply viewed, interacted with or forwarded to a contact (e.g., spouse or friend). Depending how the ad is viewed, the client module 126 reports back to a server (e.g., the server 110 or 111 of FIG. 1A), where a profile of the user is updated. More importantly, the user is paid for viewing the ad. In one embodiment, an account of the user is awarded with a payment as mutually agreed between the user and an advertiser via a publisher running the server 111. Depending on implementation, the module 126 or one of other modules 127 in the memory 124 includes a mobile version of WeChat, Facebook or other social network applications to allow a user to interact with others on the social media.

Referring now to FIG. 2A, it shows a logic relationship 200 between a client 202 and a server 204. The client 202 represents one of many clients that are intended to communicate with the server 204. Users of the clients subscribe certain ads they are interested in viewing. In return, they are compensated for viewing the ads from a plurality of advertisers 206 who are willing to pay for viewing their ads or other related actions. According to one embodiment, the ads from the advertisers 206 are distributed via the server 204. A provider or ad publisher operating the server 204 works with the advertisers 206 and is responsible for distributing the ads to the right users on one side, and determines which ads shall be sent to a user at a time or/and in a way opted-in by the user when a set of criteria is met on the other side. One of the key differences between the traditional ads campaign and the current invention is that the former distributes ads in digital media to a targeted group of users regardless they view the ads or not (mostly they don't in reality) while the latter distributes ads to those who wanted to see and guarantees that the distributed ads are accessed (e.g., viewed or listened to), inducing much more clicks-through or interactions thereon. Although the viewers are compensated for viewing the ads, the advertisers would have saved substantially since each distributed ad hits the right audience and gets accessed. It should be noted that the provider or publisher operating the server 204 can be an advertiser, an ad distributor or publisher, or a social network operator (e.g., WeChat or Facebook). Without departing the principle of the present invention, a large portion of the description herein is based on the embodiments in which an ad publisher distributes the ads via WeChat. Those skilled in the art shall appreciate distributing the ads on a similar social media, such as Facebook is possible but all falling in the scope of the present invention. In addition, given the detailed description, those skilled in the art can extend the concept to a shopping or an auction website such as Ebay (www.ebay.com) and Alibaba's Taobao (www.taobao.com)

According to one embodiment, a user interested in viewing ads for pay installs a client module in his device (e.g., a mobile phone, a tablet, a laptop or a desktop computer). When the client module is executed for the first time, the user is required to sign up with the rewarded-viewing service that distributes ads in accordance with his interests or preferences. For example, the user has expressed his interest in viewing ads in the areas of electronics, grocery, food and drinks, as a result, he may get a bargain for a large sized OLED TV in his newly remodeled living room, a discount in regular shipping at a local supermarket or a deal for lunch nearby. As will be further detailed below, these ads are allocated, delivered and subsequently accessed by the user for rewards.

FIG. 2B.1 shows a set of exemplary displays that may result from the client module being executed in the mobile device. Based on the interests expressed by the user, the server executing a server module configured to send a set of ads in accordance with the interests. Besides showing the balance in an account maintained by the user, the display 210 shows an exemplary list of ads categories, each holds one or more ads from corresponding advertisers. It may also be used to show a presence of ads, namely the user has not seen the details of each of the ads before an activation happens. In one embodiment, the display 210 is caused to be displayed when a banner in a display such as the explicit ad 116 of FIG. 1B is activated.

It is assumed that a user decides to check out deals in the category of food & drinks before lunch time. He may activate or click on the “Food & Drinks” category that may lead to a show of a list of available ads related to restaurants, special lunch or dinner deals, and drinks at local stores. For example, there are two available ads, one from McDonald's and the other from Pizza Hut, all local to the user at the time of viewing the category. The user may choose one or both to view. In the context of the present invention, these two ads are allocated especially for the user who will be compensated for viewing each of the ads if he chooses to do so.

According to another embodiment, an ad is shown when the user enters the category. The one that shows immediately or first is generally the one that the advertiser thereof is willing to pay the viewer the most. When there are multiple ads that may all fit into the interest of the user, the order of the ads may be arranged based on a pay rate the corresponding advertiser is agreed to pay. A higher pay rate may command an ad to be shown earlier to the user. As will be described below, a bidding process may take place among the advertisers per the user to secure a preferable place or time of their own ads in a queue.

FIG. 2B.2 shows an example of providing three windows (slot A, B and C) to show ads related to food and drinks to a user. The ad publisher auctions the ad positions among a group of advertisers interested in showing their respective deals to the user. Statistically, local lunch ads are most effective when an ad is shown to the user around 11:45 AM since many employees are about to take a lunch break and look for a place to eat. The first opportunity is auctioned for $0.90, which means that the ad for this spot will be displayed to the user around 11:45 AM whenever there is an opportunity to show the ad. For example, the ad is displayed in a corner of a webpage being viewed by the user on a desktop computer or when the user reactivates his mobile phone. Alternatively, an audio alert is played to attract the attention of the user to the ad around 11:45 AM.

When there are more than one advertisers desired to place their ads for this slot, the price to place the ad is incremented till there is only one advertiser left. Similarly, the price to place the ad is decremented till there is one advertiser coming to take the slot. In operation, the rate for all opportunities (e.g., 1st, 2nd, 3rd . . . with different rates) are auctioned at the same time to accommodate different types of advertisers. Since the time for lunch deal is sensitive, the effectiveness of the lunch ads goes away with the time running into the traditional lunch time. The bidding process may also auction different slots at different times. FIG. 2B.2 shows that there are three slots A, B and C, each starts to show the ads at pre-defined times. At time slot A, there are initially three advertisers bidding for the 1st opportunity. As the rate for the first, second and third opportunity increments or decrements, at certain point, the three advertisers are settled with their own ads in three different opportunities. At time slot B, the rate is lower (perhaps many lunch goers have already made their minds), only two advertisers compete for the first and second opportunities to place their ads. Similarly, at certain point, the two advertisers are settled with their own ads in two different opportunities. At time slot B, the rate is even lower (perhaps many lunch goers are almost done with their lunch), the rate for first opportunity is periodically or continuously decremented till there is one advertiser coming to place an ad for a bargain.

According to another embodiment, the bidding process may be expanded to auction an opportunity after a certain action. For example, after an ad is shown to a user and there is a click-through resulting in a successful transaction of an item in the ad, another ad supplementing or expanding the use or consumption of the item may be particularly appealing to the user. Such a supplemental ad opportunity, nevertheless, is conditional per se as it is based on a follow-up action (that may or may not happen) on the previous ad and may also be auctioned among relevant advertisers.

Referring now back to FIG. 2B.1, when an opportunity presents, an ad is shown. If the user is interested in the item being promoted in the ad, he may proceed by clicking it (a click-through happens). If the user is not interested in the ad, he may continue to a next ad. Nevertheless, the ad has been viewed so the user gets compensated. The display 212 is an example either selected from the category by the user or an automatic display based on an order in a queue per an arrangement. It is assumed that the user is interested in the ad and interacts with it to bring up the display 214 to show the location of the place, a corresponding phone number or an electronic coupon (e.g., 1-D or 2-D barcode or symbol) that may be scanned or read when the user uses it at a checkout counter. In one embodiment, the ad or the coupon therein is personalized per the user so that the advertiser/publisher can be electronically notified that the ad has been utilized. In addition, the display 212 may also show an electronic map or activate a map application such as Google Map to show how far it is from where the user is now and the routing direction.

In one embodiment, the client module includes an electronic purse that is credited with a payment from the advertiser for the user to view the ad therefrom. The payment is a reward from the advertiser to the user for viewing the ad. When a mobile device is loaded with WeChat application, the red envelope in WeChat can be used as an electronic purse for the user thereof to receive the payment. The balance in the display 210 is an example of showing what the user has earned (e.g., $347.89) by accessing the targeted ads and what he has in the electronic purse (e.g., $1023.58). depending on implementation, the balance may show only what the user has earned by accessing the targeted ads or both as shown in the display 210.

In general, the payment or payment rate is different from one user to another depending on a profile or the behavior history of a user. For example, if the profile indicates that a user thereof seldom eats fast food, an advertiser of fast food would pay far less reward amount to him than another user indicated to eat fast food at least 5 times a week. Likewise, a TV manufacturer or store would pay a much higher reward for its ad to a user currently shopping a TV than a user who is really not in the market for TV.

When a user clicks through a displayed ad, his profile is updated. Depending on the nature of the ad, the reward for viewing the same type of ads may be increased or decreased. In the event as shown in FIG. 2B.1, the user has clicked through the ad and even visited the local McDonald's, the commission to view another McDonald's ad is increased because the advertiser anticipates that it is likely that the user may view a similar ad and click through it again, and eventually utilize the ad. Nevertheless, a TV manufacturer or all advertisers for TVs would pay far less reward or none after the user has viewed a TV ad, clicked through it and eventually utilized the ad by buying a TV because not many consumers would immediately buy another TV right after having purchased one.

According to another embodiment as shown in FIG. 2C, the ad publisher 204 may cooperate with a content publisher 224 to place the relevant ads in lieu of the ads selected by the content publisher 224. In operation, a content publisher (e.g., a publisher on Moments of WeChat or an operator of www.163.com) gets a bulk of ads from a plurality of advertisers 226 or an ad network. When a user accesses the content, the content publisher relies upon stored cookies or keywords to place some ads in the pages being visited by the user, hoping the user may click on one of the ads. However in reality, very few of these ads are being seen or activated by the user. In one embodiment, the ad publisher 204 works with the content publisher 224 to place its user-targeted ads where the content publisher 224 is planning to place their ads. As a result, the ads are likely viewed by the user as the user is paid to view the ads. On the other end, the content publisher 224 receives a percentage of fee paid by an advertiser to the ad publisher 204.

FIG. 2D shows an example of advertising in an article shared with others or published on Moments of WeChat. The article may have been authored by user A who is a contact of user B. The article is embedded with one or more ad links that may be added by an authoring tool, user A or other means, hoping someone would access one of the links when reading the article. Such an article may be distributed to a user on WeChat via messaging or posting on Moments. When user B receives and activates the article, by the time the end of the article is displayed in a display 230 shown in FIG. 2D, there are several ads 232. It is assumed that user B is female, the ads 232 are mainly related to items wearable by a man. In general, the ads in the links would not be of interest to user B. In one embodiment, the ads or the links are substituted by or redirected to allocated ads for user B. As WeChat maintains an account of user B, some ads can be allocated based on the profile of user B or expressed interests by user B. A display 234 shown in FIG. 2D shows the same article but with allocated ads that are of interest to user B who is very likely to access the ads therein. More important, user B is compensated for accessing the ads in the links 236.

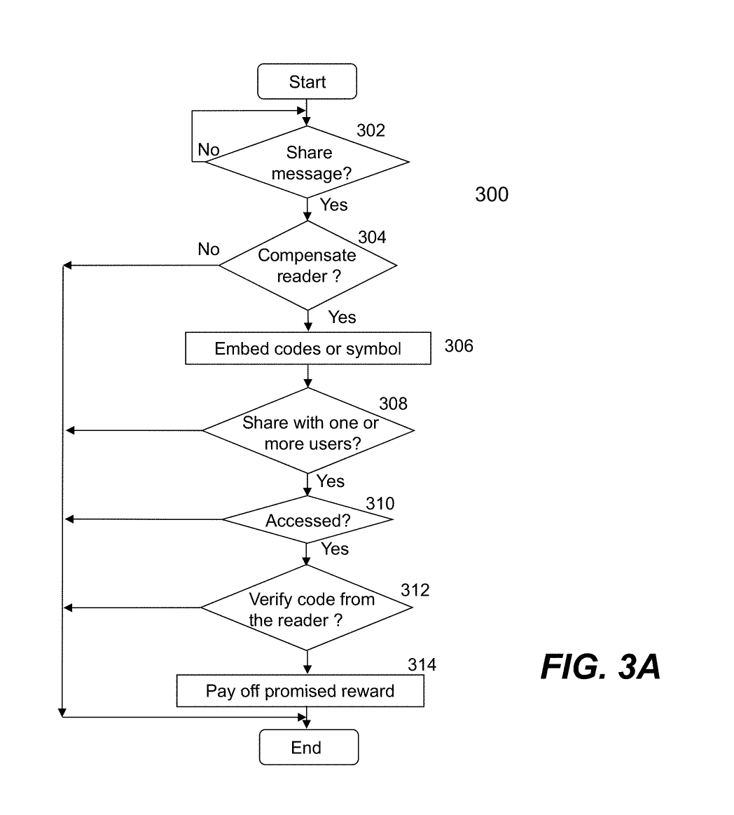

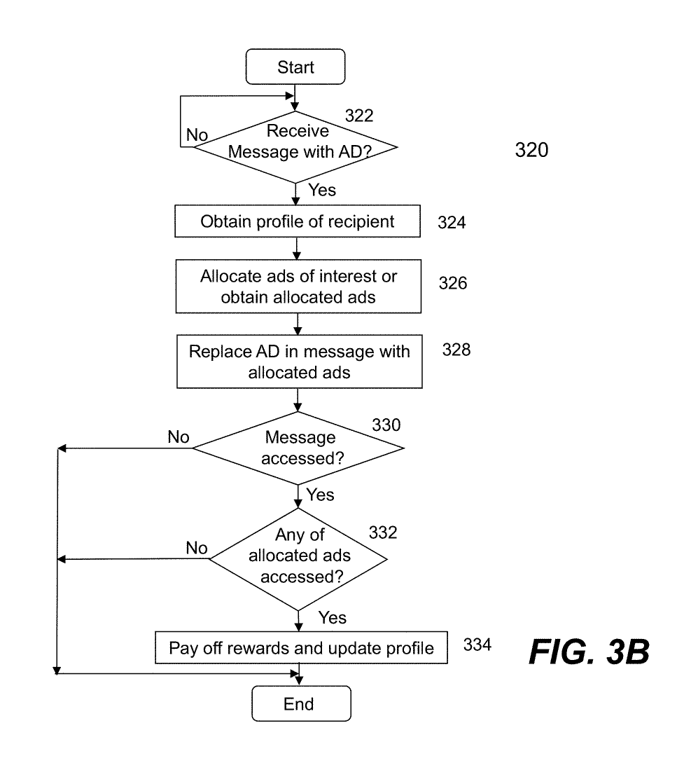

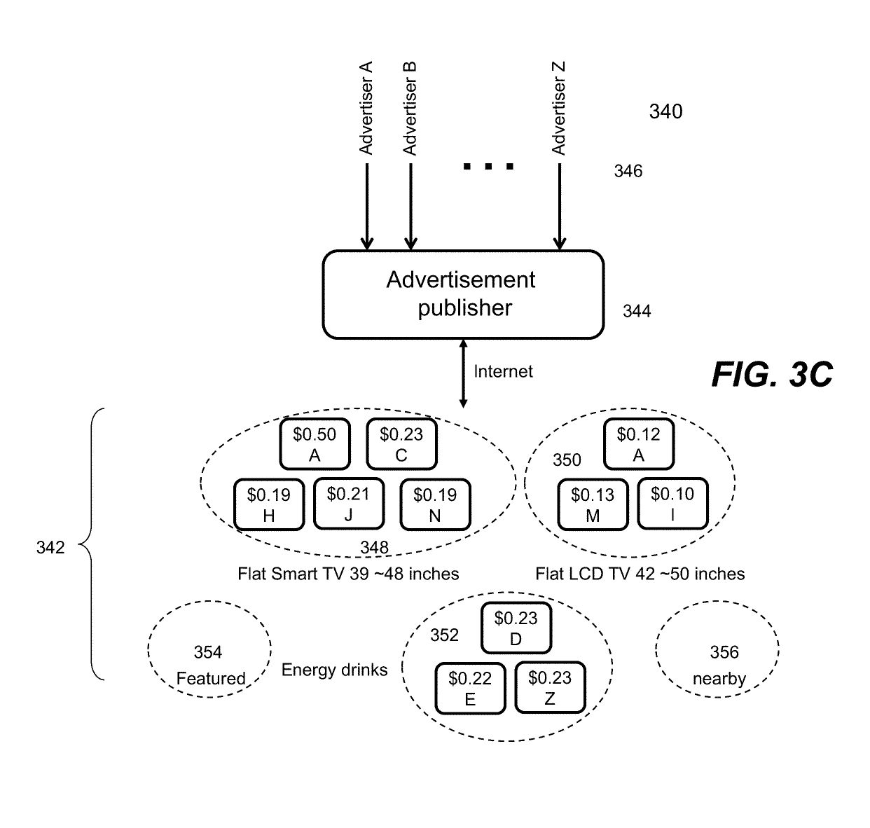

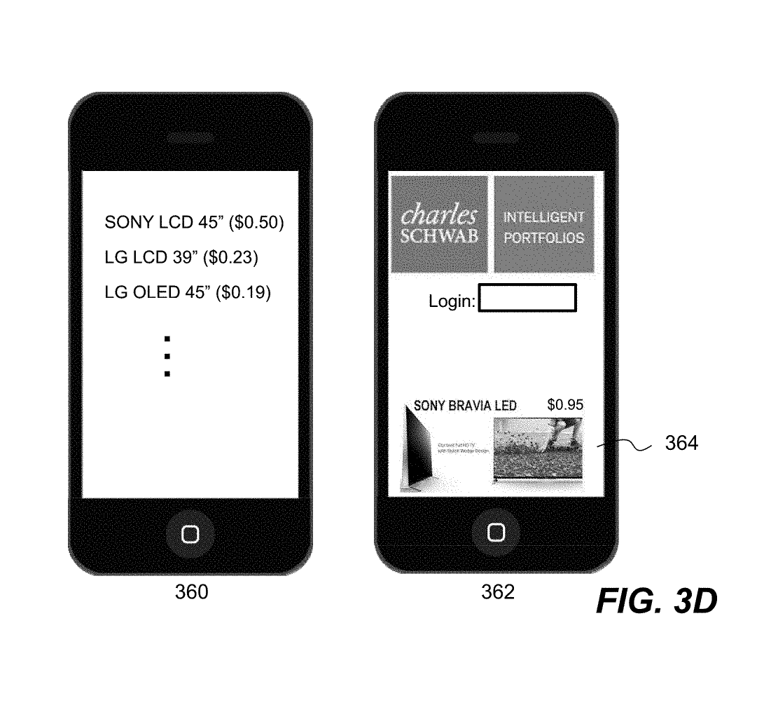

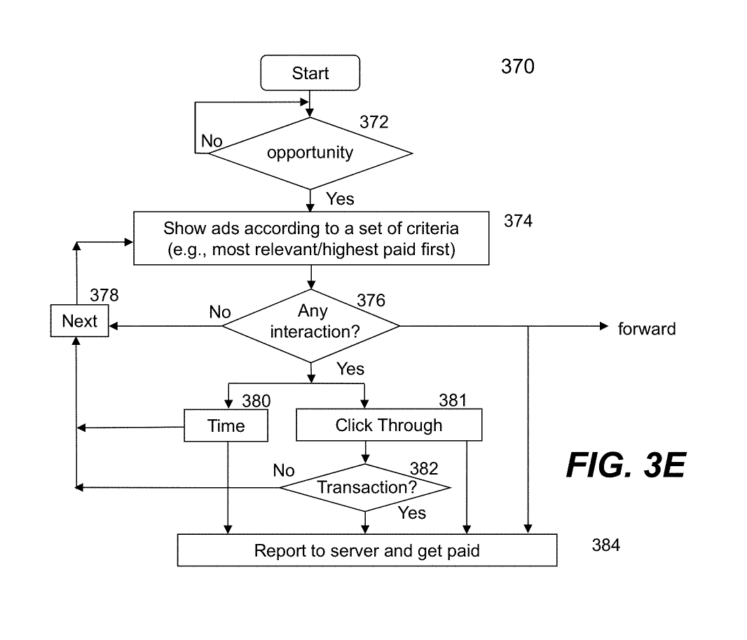

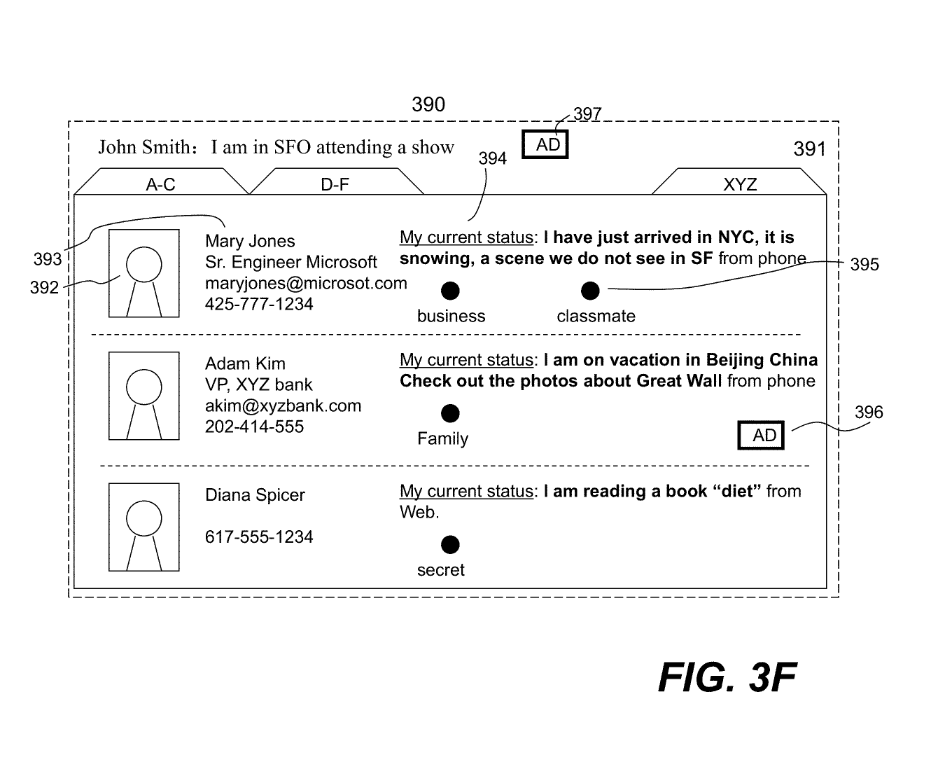

Referring now to FIG. 3A, it shows a flowchart or process 300 of compensating a designated reader for accessing a message. As defined above, a message can be in any form (such as a text, a graph, a photo, a hyperlink, an audio, a video and etc). The process 300 may be understood in conjunction with the preceding drawings and implemented in software or a combination of software and hardware. According to one preferred embodiment, the process is implemented in a client module and a server module, each must be loaded in a computing device.

The process 300 only proceeds when a message is determined by user A to be shared with user B at 302. The process 300 goes to 304 where user A decides whether user B is compensated or rewarded if user B shows that he has indeed accessed the message thoroughly. The process 300 only proceeds when the message is to be shared at 304.

To ensure that the reader reads through the message, at 306, the author (e.g., user A) of the message embeds or identifies some symbols, characters or unique signs (a.k.a. codes) in the message and requires the reader (e.g., user B) to report these codes back to user A for the recognition of accessing the message. Depending on the nature of the message, user A may a set of codes to be distributed across the message or identify some unique things in the message. For example, user A may add a set of codes “adt53” and distribute each of the codes at the end of a paragraph or nest to a photo in the message. Alternatively, user A may identify each of the codes as an ending time of an act or event in a video click. In any event, user A may use any identifiable marks in a message as one code or a part of a code set to request a reader to report what the reader has noticed when accessing the message in full. At 308, user A may share the message with user A or other users in any means including email, messaging, the Moment of WeChat or NewsFeed of Facebook.

At 310, the process 300 awaits the message to be accessed. In the example shown in the display 113 or 115 of FIG. 1B, the presence of a shared message is not considered to have been accessed if the user does not activate on the message to bring up the details thereof. The process 300 only goes on to 312 when the user, namely user B, activates the message (e.g., a graphic book 117 or video footage 2016 Chinese New Year Gala) to bring up a separate display to show the detail of the message, in which case user B is instructed to collect the codes while accessing the message. User B then reports the uncovered codes to user A for verification and compensation or rewards.

At 312, user A receives the codes found or uncovered by user B in accessing the message. If the codes are not what user A has originally designed, which could mean that user B may not be careful enough to read through the message assuming the message is an article or a collection of photos, watch the message in full length assuming the message is a video clip, or listen to the message carefully assuming the message is an audio clip. User B may choose to go back accessing the message again till the reported codes are confirmed by user A. At 314, user B is compensated for accessing the message imposed by user A upon user B. One of the advantages, objects and benefits in the present invention is to ensure a message is fully accessed by a reader, in return the user is compensated for the time he spends in accessing the message.

Referring now to FIG. 3B, it shows a flowchart or process 320 of compensating a reader for accessing ads in a published message. Depending on situation, the message is embedded with one or more ads. In general, these ads are links, in other words, they needed to be activated in order to show the details of the ads although it is possible to embed an explicit ad right in the message. In any case, a reader is compensated for accessing one or more ads in the message. The process 320 may be understood in conjunction with the preceding drawings and implemented in software or a combination of software and hardware. According to one preferred embodiment, the process is implemented in a client module and a server module, each must be loaded in a computing device to realize at least one aspect of the present invention.

At 322, a server operated by a social media (e.g., WeChat) determines if it receives a message that is meant to user A or a group of contacts selected by user B. The message may be forwarded to user B who decides to share it with user A or his selected contacts. Alternatively, the message may be authored or assembled by user B. In any case, the message includes or may be caused to include one or more ads or ad links. Before the server pushes the message to user B, the server looks up the profile of user B at 324 to determine what user B would like to buy or what types of ads user B has expressed to see.

Based on the profile or interest of user B, the server is then caused at 326 to load some of the allocated ads specifically for user B or ads that are of great interest to user B. Depending on various parameters (such as, the time, weather condition, temperature of the day, the season, the location, what the user likes or dislikes, a reward level the user is generally interested in, a reward amount an advertiser is willing to pay, and etc), the server is configured or programmed to select one or more allocated ads that are deemed appropriate for the user at 326, and replace the ads originally in the message with these allocated ads at 328.

At 330, the process 320 awaits user B to access the message. Sometimes, user B does not bother to access the message. As a result, the process 320 goes to end. In one embodiment, an alarming mechanism (such as color changing, animation, or flashing) may be embedded in the message to alert the user to access the message. It is now assumed that user B is interested in checking out the message. In operation, user B clicks the message, the message is loaded in from the server and a display of the message is shown on a screen. User B shall have the opportunity to see the ads or links somewhere in the message. If the user understands that he will be compensated for accessing the ads, he activates the ads at 332, resulting in another display to show the details of the ads. At this moment, the user is rewarded according to a pay rate defined by the corresponding advertiser. Should the user forward the message to one or more of his contacts, the server is notified of the request(s) with who the message shall be forwarded to. At this moment, the user is rewarded with additional rewards for forwarding the message to other contacts of his, resulting in more access to the ads in the message. In the meanwhile, the server repeats the process 320 for the identified contacts of user B.

It should be noted that the process 300 or 320 is not something a general computer is capable of performing by itself. A general computer must be specifically programmed or installed with a specifically designed module according to one embodiment of the present invention. As will be further demonstrated, the process 300 or 320 undertaken between two computing devices (e.g., a server and a client) is not a collection of human activities as it is practically impossible by any measure for some of the procedures to be performed by or to involve the intervention of human beings. With the execution of a client module or a server module implementing one embodiment of the present invention, the two computing devices are caused to perform beyond what they are originally capable of or meant to do. Each of the processes 300 and 320 is be implemented in software or a combination of software and hardware as a module that must be loaded, installed and executed to cause a computing device to perform one or more desired functions.

It is assumed that a user is using a client (e.g., a smartphone or a computer) that has been installed a client module (e.g., the module 126 of FIG. 1C). The module is activated manually or automatically upon an event. Depending on situation, the user may manually activate the client module by clicking on an icon or link representing the client module or the client module is automatically activated by an application, a webpage being visited, a stored cookie or at a specific time.

When it is the first time the user uses a social media such as WeChat or Facebook, the user is requested to complete a sign-up process. Depending on implementation, the sign-up process may require some inputs from the user to establish a profile thereof. Depending on implementation, the profile may be initially formed or gradually updated with some or all of the following: real name of the user, residential address, email address, hobbies, what kind of ads interested to view, an account where a credit or points can be settled with. In addition, there may be a question of what the user is planning to buy immediately, in a week or a month or so. The question may be asked late or supplemented with questions of any preferred brand, model, size, color, quantity, or price range, and etc. Sometimes, the user has purchased something somewhere else while the profile still indicates that the user is planning to purchase the item, in which case sending ads pertaining to the item would be no longer effective.

As described above, a user is compensated for viewing an ad. From the perspective of an advertiser, an ad is delivered to a user who has expressed an interest in viewing it, which significantly increases the chance of a click-through. It should be noted that a click-through is defined as a process of a visitor clicking on or activating an ad and going to another place referenced in the ad (e.g., a website of the advertiser). The click-through rate measures the amount of times an ad is clicked versus the amount of times it is viewed. One of the purposes of the bidding process is to ensure that an ad publisher and the user reach an agreement that the publisher is authorized to send various ads in accordance with the expressed interests of the user and the user will view them for a pay.

According to one embodiment, a user can list his preferences initially or modify the list late. For example, the user is interested in seeing ads in the areas of electronics (or more specifically LCD TVs in 30-40 inches) and meal deals for lunch. Thus an ad publisher or a social medial operator allocates ads relevant to the preferences and causes these ads to be allocated for the user or loaded into his smartphone. With the loaded ads, the allocated ads can be selectively shown when the device is offline (off the Internet). When the device is online, either stored ads or ads from a server may be shown. Further in the cases of using mobile devices, the pre-loaded ads can be shown at various moments. FIG. 3C shows an example 340 of allocating relevant ads 342 for a user using a device (not shown). It is assumed that the user has provided a list of his preferences (e.g., discounts/promotions from all local stores near his location, energy drinks and featured products/services in his area) in addition to his desire of buying a flat smart TV in size of 40-45 inches in the next one or two weeks. The publisher 344 works with a plurality of advertisers 346 (e.g., advertisers A . . . advertiser Z). In accordance with the listed preferences of the user, the publisher 344 allocates a group of ads 342. It shall be noted that it may appears that the publisher 344 has to work with the advertisers and manually allocates the ads 342 for the user, but the allocation of the ads is actually done automatically without much intervention of human activities. In one embodiment, the server operated by the publisher 344 executes a server module that is invented, uniquely designed, implemented and configured to dynamically allocate the ads 342 given a set of criteria per the listed preferences for each of its registered users.

For example, some of the ads in the ad group 342 may not be there or automatically excluded at a certain point. For example, all ads related to lunch deals in the featured ad 354 are excluded (e.g., replaced or not for showing) when it comes to late afternoon or dinner time. Likewise, all promotions related to winter clothes in the nearby ad category 356 are excluded when the user travels from Guangzhou to Beijing in the month of December. Further, some or all of the ads in 342 may be stored in local storage of the client or provided online when the client is connected to the Internet. In other words, when the client is offline, the client module being executed in the client is activated to retrieve the stored ads to show when there is an opportunity. As described above and further below, an opportunity for showing an ad can be a moment opted-in by the user, for example, before, during or after an application, ad insertions in a visited webpage or appearing on a lock-up or idle screen, and etc. In the context of the present invention, the opportunity is a moment when the user activates an embedded ad or ad link in a message being shared between two users or published on something similar to the Moment of WeChat or NewsFeed in Facebook.

Since the user has expressed a desire to buy a flat smart TV in size of 40-45 inches in the next one or two weeks, the advertisers of the TV are offering relatively a higher rate to reward the user to view their ads. In one case, one of the advertisers is offering a TV almost exactly matching what the user may be looking for, in which case the pay rate by the advertiser may be even higher (to attract the user to view it) or sometimes lower (the user is believed to get into the deal anyway). As an example, the ad group 342 shows some ads 348 for flat smart TV 39-48 inches (covering the range specified by the user). Some of the ads in the group 350 for TVs are substantially similar to what the user is looking for, others may be slightly off, different ads offer different pay rate, hopping the user may eventually end up with their products.

As described above, the ads (or categories) 352, 354, and 356 are allocated for a user based on the updated profile or preferences of the user. According to another embodiment, the ads (or categories) 352, 354, and 356 may be determined based on data pertaining to historical activities. When the user interacts with applications, websites or displayed ads, the activities can be captured as data. Further, the locations of the user, where or when he normally goes, when the user wakes up his mobile, the first thing he normally does, even when he charges his mobile device or alters the audio or brightness of the display screen, and how many rings he picks up an incoming call and etc, all can be captured as data. When all sorts of data about the user are gathered together in a server, the data is processed in an effort to identify patterns and associations so that relevant ads can be allocated to effectively induce the user to click through some or all of the ads.

FIG. 3D shows two examples of displaying the ads on a mobile device the user is using. The display 360 shows that there are a number of relevant ads, each showing a different TV with a pay rate in which the user may be interested. It is an example of an agreement between the advertiser and the user. The user may view some or all of these allocated ads for the listed reward. In one embodiment, the pay rate or the order of the ads is dynamically changed subject to, for example, an action from the user to a viewed ad. For example, when the user views the first ad in the display 360 and does not do anything (no click-through), the server module is notified and configured to adjust a couple of ads up in the order as well as in the pay rate in a belief that the user may be interested in a smaller size or a different LCD TV. In any case, the allocated ads may also be shown in another opportunity as shown in the display 362 in which there is a relatively large space to insert or overplay a relevant ad 364 from the allocation 342. As an example, the ad 364 may also include a pay rate for the user to know how much he will be awarded if he activates the ad to view the details thereof.

According to one embodiment, the publisher 344 is configured to add less relevant ads based on the expressed desire from the user. Instead of completely not showing any ads related to non-smart flat TV, the publisher 344 may also allocate some ads 350 related to regular flat TVs, even in a broader size range as some consumers may change their minds when they see a great deal of something that is not exactly what they originally wanted.

Given the example that the user has expressed his desire to buy a flat TV in the next one or two weeks, TV manufacturers, stores or distributors would like to get the user to view their own promotions and may compete for the user. For example, one offers one pay rate for viewing its ad, and another offers another pay rate for viewing its ad. With all the considerations including other allocated ads (e.g., the categories 350, 352, 354, and 356), depending on implementation, the publisher 344 decides how, when and where to present an ad in the best interest to its own business, an advertiser or the user.

FIG. 3E shows how to report an activity of viewing an ad according to a predetermined set of criteria. The process 370 starts when there is an opportunity to present a selected ad at 374. Regardless where, when and how an ad is presented on a display of a client being used by a user, the user can see the presence of an ad or view the ad directly. The ad may come in as a banner in graphics or text or in video, awaiting the user to interact with it to show the details of the ad. In the case of an ad being stationary (e.g. a banner or a message), a click on it shall bring the user to a more detailed ad or right to a site (e.g., a specific website or webpage showing the item or service being promoted). In the case of a video ad, the video is automatically played back but allows the user to interact with it anytime during the video. A click on it shall bring the user to a specific website or webpage showing the item or service being promoted.

While an ad is being shown, the process 370 at 376 determines if a displayed ad has been interacted with. After a certain period (e.g., 2 seconds), the process 370 goes to 374 to display a next ad via 378. When the user interacts with a displayed ad, the client module is designed to monitor the process of viewing the ad by the user. In one embodiment, it measures at 380 how long the user has viewed the ad before clicking it and how long the user viewed a website referenced by the ad. The time is captured and reported to the publisher (the server) that may update the profile of the user to facilitate the allocation of ads therefor. It may also monitor at 381 how the user views the site (e.g., navigating through some sizes, colors or others before entering a quantity). If the user quits after viewing the site or before completing a transaction, the behavior or activity is captured and reported at 384 to the publisher. Should the user enter a transaction with the site at 382, the client module captures the transaction (not necessarily the details of what the user has purchased) at 384.

Referring back to 376, when viewing an ad, the user may want to forward or refer the ad to his contact(s). According to one embodiment, a link to the ad is provided, the user may copy the link to the ad and paste it in a message or email to his contact(s). The user may also publish the message in his social network page. Any of the forwarding actions may be reported to the publisher via 384. Depending on implementation, the user may be awarded an additional incentive to do so or even when the forwarded ad is viewed by his contact(s), his contact(s) decided to sign up with the ad rewarded-viewing service or his contact(s) is ended up with purchasing an item being promoted in the ad.

FIG. 3F shows an exemplary webpage on a social network, where a user maintains his own pages, one of which 390 shows a list 391 of contacts established by the user. The list 391 shows three entries or contacts, each showing a photo or a cartoon FIG. 392, a brief indicator 393 of a contact, a status quote 394 and a relationship classifier(s) 395. According to one embodiment, when a user is ready to sign up for the ad rewarded-viewing service, the user may use his username/password of his account on the social network to establish his account for the ad rewarded-viewing service. As a result, the client module is able to access his personal page on the social network. Whenever the user desires to share an ad he believes that may benefit or be of interest to his friends, he can simply forward the ad to his contact(s) on the social network. The webpage 390 shows that the user has forwarded an ad to one of his contacts named “Adam Kim”, where the shared ad 396 shall be accessible or viewable by Adam when Adam logs in. Alternatively, the user may simply post the ad 397 on his personal page, any of his contacts visiting his personal page shall see the ad 397. As described above, should one of the contacts view the ad 396 or 397, the user may be awarded with an extra payment.

According to one embodiment, when a non-registered (new) user wishes to view the details of an ad (e.g., to play back a video ad), the new user is required to sign up for the ad rewarded-viewing service. The new user may also download a copy of the client module into his mobile device from which the sign-up process may be started. By allowing a registered user to forward an ad to a new user, the ad rewarded-viewing service can be populated with more users, thus advertisers can have a large audience to receive their ads. In the context of the present invention, the ads are directly reaching the eyes of consumers who have expressed certain interests in items being promoted in the ads, resulting in the most efficient delivery of the ads.

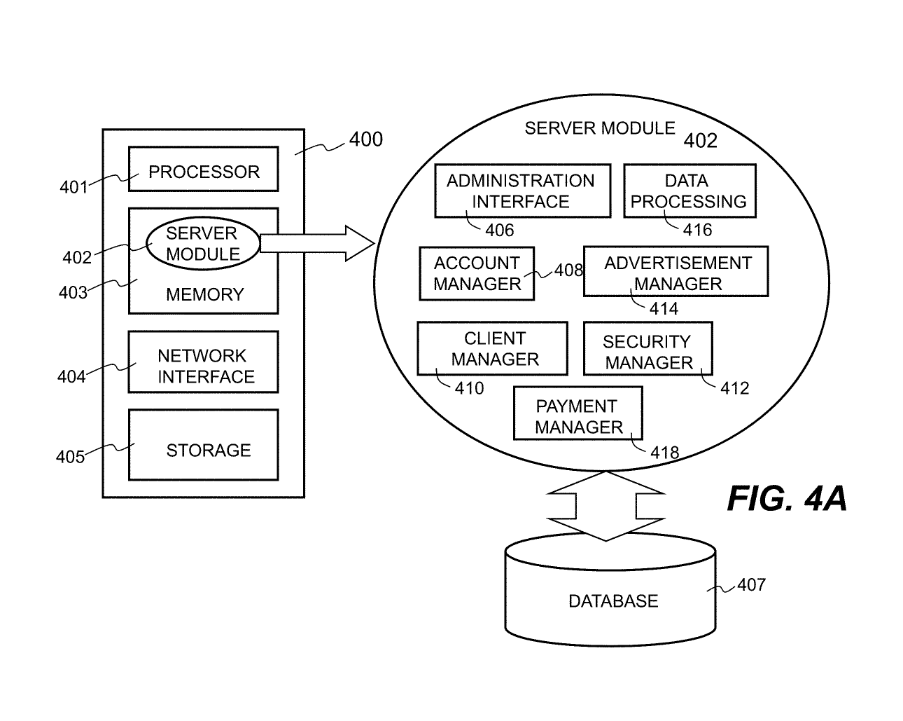

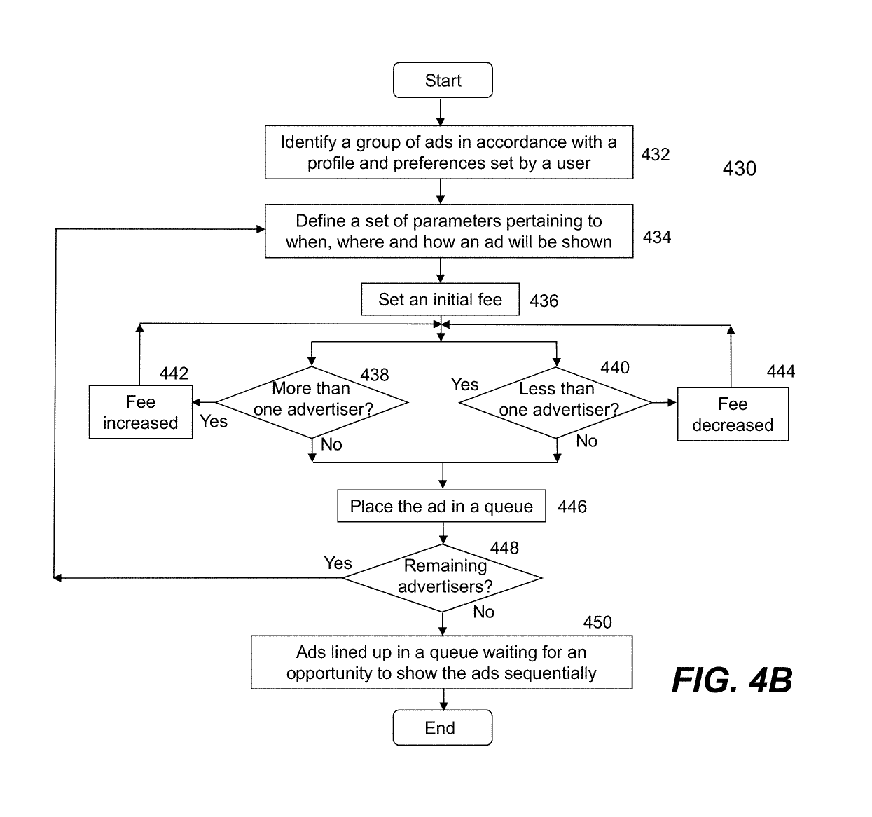

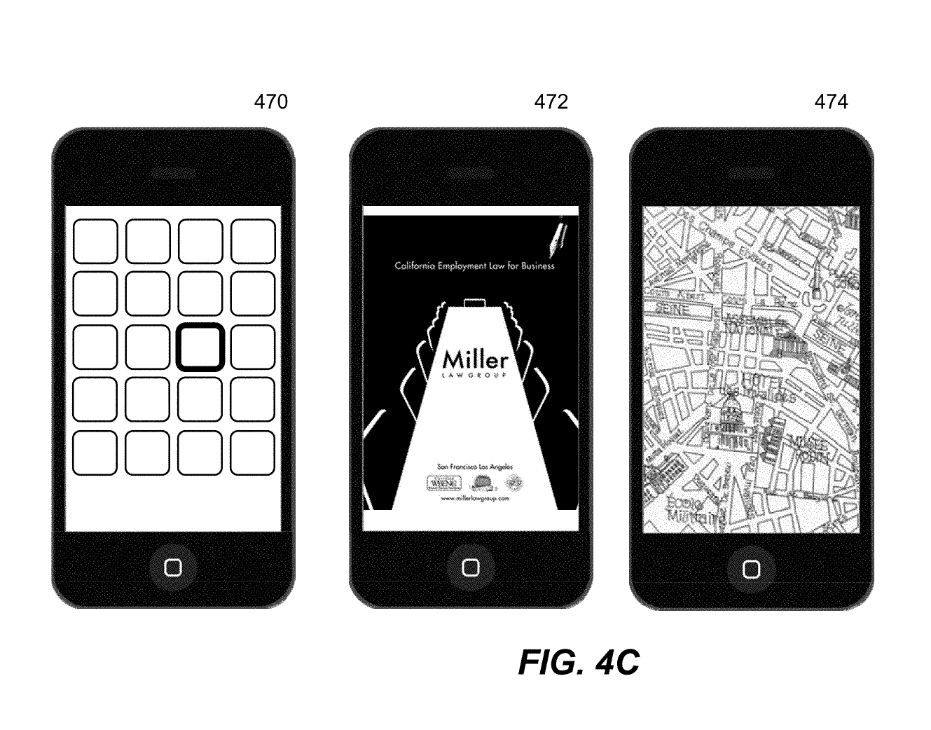

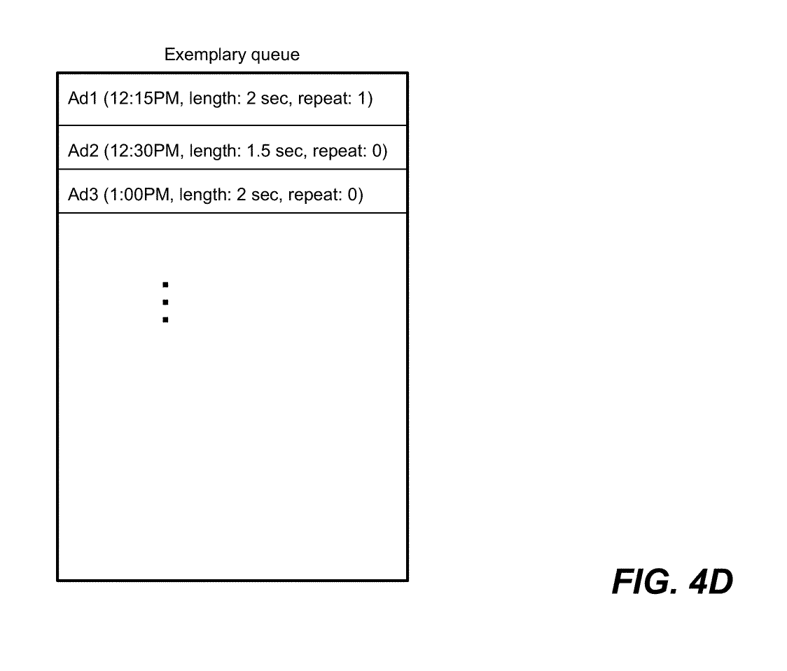

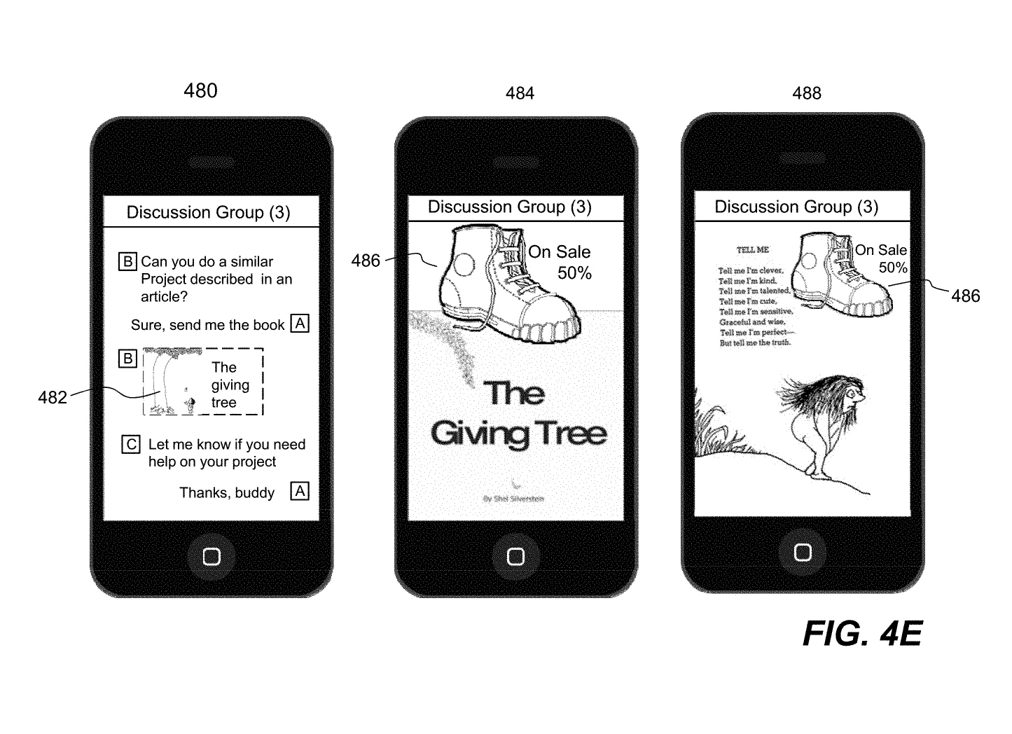

Referring now to FIG. 4A, there is shown a functional block diagram of a server 400 in which a server module 402 resides in a memory space 403 and is executed by one or more processors 401. The server 400 is a representation of many similar servers operated by an ad publisher and may be used in FIG. 1A to facilitate the allocation of ads for each of subscribers or users, arrangements between the advertisers and each of the users, and settlements of payments or points towards the viewing of the ads.

Depending on implementation, this server 400 may be a single server or a cluster of two or more servers. One embodiment of the present invention is implemented as cloud computing in which there are multiple computers or servers deployed to serve as many businesses or individuals as practically possible. For illustration purpose, a single server 400 is shown in FIG. 4. Besides providing the ad rewarded-viewing service, the server 400 is assumed to support a social media platform (e.g., WeChat or Facebook). Further, the server 400 includes a network interface 404 to facilitate the communication between the server 400 and other devices on a network, and a storage space 405. In one embodiment, the server module 402 is an executable version of one embodiment of the present invention and delivers, when executed, some or all of the features/results contemplated in the present invention. It should be noted that a general computing device is not able to perform or deliver what the server 400 is equipped to do without the installation of or access to the server module 402.

According to one embodiment, the server module 402 comprises an administration interface 406, an account manager 408, a client (advertiser) manager 410, a security manager 412, an advertisement manager 414, a data processing module 416 and a payment manager 418.

### Administration Interface 406:

As the name suggests, the administration interface 406 facilitates a system administrator to access various components in the server module 402 and set up various parameters of the components. In one embodiment, a publisher (e.g., a social media operator) uses the administration interface 406 to determine a spread for its profit. For example, an advertiser is willing to pay $0.90 for a user to view an ad. The publisher may extract a fee (e.g., 25%) on the payment from the advertiser, thus the maximum the user can get paid is $0.675 (75%×0.90) for viewing the ad. In another embodiment, the administration interface 406 allows a publisher to manage all subscribing accounts for the advertisers and determine what and how much to charge for servicing the advertisers. In addition, advertisements in digital forms are received from the advertisers and kept in storage 405 or a database 407 via the administration interface 406.

### Account Manager 408:

The account manager 408 is provided to manage all accounts registered with a social media platform or the server 400. In general, there are two types of accounts. The first group of accounts are for those who have agreed to receive various messages somehow matching their interests explicitly expressed their profiles and/or updated automatically overtime based on their activities. In other words, the users in the first group receive various targeted messages from publishers or sponsors and have the opportunity to view them for compensation. The second group of accounts are for those who chose not to be intruded by unrelated contacts, therefore will not receive any targeted messages. In the context of the present invention, the description herein is primarily for the first group of users. In operation, the account manager 408 allows a user to automatically register himself with the server 400 for the rewarded-viewing service being offered by the server 400 or register with a client module running on his mobile device, where the client module is designed to cause his mobile device to communicate with the server 400 via the interface 404. In one example, a user causes the client module to be executed for the first time on his device (e.g., iPhone), the module is designed to request the user to enter certain information (e.g., username/password, a fingerprint, a true name and etc.) before allowing the user to create a profile including an account for receiving a payment. In one embodiment, a user is allowed to link his electronic wallet to his account. Whenever there is a settlement or payment from a sponsor, an advertiser or an ad publisher, the payment goes to his electronic wallet. After the registration, a profile of the user is created and then transported to the server 400. According to one embodiment, the account manager 408 indicates to the server 400 that a user who has expressed a plan to purchase an item (e.g., a TV or a tablet computer), the server module 402 is designed to take a special care of the user by notifying the advertisers of the purchase intent from the user. Depending on implementation, some advertisers may make a special promotion of the item or items similar to what is in the mind of the user. The promotion may be one or more of a special discount, a voucher, a rebate or other appended services/products. Not only viewing messages or ads from sponsors or advertisers for a competing payment, the user may get additional perks by clicking through all the way to a successful transaction of purchasing an item being advertised.

### Client Manager 410

The client manager 410 is provided to manage versions of client modules provided to the users. In one embodiment, besides keeping updates to the client module, there may be two versions of it, one for the first group of users and the other for the second group of users as described above. Depending on implementation, these two versions of the client module may be implemented as a single module or two separate modules. In the context of the present invention, the client manager 410 controls when to switch from one version to another in accordance with a set of parameters about a user. In operation, the client manager 410 is notified which version or release a registered user is using. In addition, to ensure that the ad rewarded-viewing service is working seamlessly with a social media, different versions of a client module for different social media platforms are provided. If a user has downloaded an App from Facebook, a client module working with the Facebook App is automatically provided and supports various interactions in the Facebook platform. Likewise, If a user has downloaded an App from WeChat, a client module working with the WeChat App is automatically provided and supports various interactions in the WeChat platform. As a result, various functions of rewarding a user for accessing an allocated ad or a message can be incorporated in a social media.

### Security Manage 412

This module is configured to provide security when needed. The stored data for each of the subscribing businesses or registered users may be encrypted, thus only an authorized user may access the secured data. For example, all personal information of the users, especially the accounts set up by the users to receive the payments for viewing the ads are stored securely. In one embodiment, the security manage 412 is configured to initiate a secure communication session with a client device when the user of the client device shall be paid. The secure session allows a payment to be made to the designated account. In addition, the profile and preferences provided by the user are also secured by the security manager 412.

### Advertisement Manager 414

The advertisement manager 414 is a tool provided to allocate one or more advertisements for a user in accordance with his provided profile, where the advertisements are chosen based on certain criteria set by the ad publisher or/and the user. Depending on implementation, the criteria may be based on a profile provided by the user or a profile retrieved from a social network, where the user allows an access to his profile on the social network and shares his interests with others there. In addition, the publisher has also established the criteria as so a purchase history, a historical browsing habit, possible buying power and other considerations. For example, the advertisement manager 414 would never allocate female cosmetic advertisements to a male user. Likewise the advertisement manager 414 may be designed not to allocate female cosmetic advertisements to a female user if it is detected that the female user has never clicked through a cosmetic advertisement. In operation, the Advertisement manager 414 is designed to periodically or constantly reallocate advertisements for each of the users based on a set of parameters to maximize the delivery and usefulness of the respectively allocated ads.

### Data Processing 416:

This module is configured to perform analytic operations to determine which ad to be shown next after a user has viewed one ad. As will be further described below, this module in conjunction with the account manager 410 is designed to insert an allocated ad in a message. For example, an allocated ad may be inserted in the beginning, in the middle or at the end of a message sent to a user who has agreed to view an ad for pay. Given the information provided by a user and the payment range by an advertiser or the publisher, the data processing module 416 determines a set of ads in an order for the user. In operation, the data processing module 416 is designed to be periodically or continuously executed to keep the allocated ads in an order that is believed to be most effective. As shown in FIG. 3C, there may be a few ads from one or more advertisers that are believed suitable for a user, each ad is set for a price for the user. When two or more ads are substantially similar, the order of showing the ads is very important for certain items. A user may click through an ad and complete a transaction with the ad, resulting in subsequent similar ads relatively or completely useless. According to one embodiment, whenever such a transaction happens, the data processing module 416 is designed to calculate a set of parameters that cause the advertisement manager 414 to reallocate some or all of the ads for the user. In one case, the subsequent similar ads are withdrawn or the price for each of the subsequent similar ads is significantly reduced. In another case, the data processing module 416 is designed to calculate a set of parameters that cause the advertisement manager 414 to allocate new ads of items or services that could supplement or expand the use of the purchased item by the user. In the above example of purchasing a smart TV by a user, once the transaction of the purchase is done, further TV ads would be ignored to avoid the waste of money offered by TV manufacturers or TV stores for viewing their TV ads. Instead, it would be much more efficient or useful to send ads related to a cable service or TV accessories or other services (e.g., HDMI cable, surrounding speaker system or extended warranty). In still another case, the user may want to delete an advertiser (perhaps the user has had a bad experience with a product from the advertiser) or add a preferable advertiser (perhaps the user is fascinated with a brand from the advertiser), the data processing module 416 is designed to calculate a set of parameters that cause the advertisement manager 414 to reallocate ads for the user every time there is a change to his profile or an action to a viewed ad. According to another embodiment, certain social network pages (e.g., Facebook) owned by a user are crawled to determine an interest of the user from his interactions with certain applications or visits to certain websites. It is assumed that such access is permitted or opted-in by the user. The retrieved data is analyzed by the data processing module 416 so that the advertisement manager 414 can update or allocate ads for the user.

### Payment Manager 418:

As the name suggests, this module is designed to settle the payment with a user after the user views one or more allocated ads for him. In operation, this module works with the account manager 408 and the data processing unit 416 to ensure that an allocated ad is viewed by the user and the user is compensated for viewing the ad. Should the user have done something extra about the ad, the user is awarded with an extra payment or payments. As described above, when viewing an ad, the user may click it though, result in a transaction from it, forward it to a friend or post it on a whitewall on social network and etc. Each or all of the subsequent actions may get the user some extra payments for viewing the ad. Afterwards, the payment is made electronically by the payment manager 418 to a designated account by the user. In one embodiment, the payment manager 418 settles the payment with an account in a mobile device associated with the user.

Referring now to FIG. 4B, it shows a flowchart or process 430 of forming a queue of ads to be shown to a user. It may be better appreciated in conjunction with the preceding figures and implemented individually or collectively with the processes 300 and/or 370. Depending on implementation, the process 430 may be implemented in software or a combination of software and hardware.

At 432, based on the profile, preferences, and/or analysis of collected data about a user, a set of ads are identified, which means these ads may be of some interest to the user. At 434, a set of parameters are defined for each ad opportunity. As described above, the user has opted in or agreed to accept certain ads to view for payment. In particular, the user may have identified where, when and/or how these ad may appear. Besides, he has the option to activate an application to view some or all of the allocated ads. The user may allow an ad to appear before a selected application is fully launched or a webpage is fully loaded. FIG. 4C shows an example of ad opportunity before an application is fully launched. It is assumed that the user has activated a selected application (e.g., a map application) in display 470. Typically, the map application needs to determine where the user is located currently so his location can be shown in the map when the map is displayed. If the user has newly landed in a place, his mobile device needs to update what is called a map database to reconstruct a map for the new place. If the user has allowed to show an ad before an application is launched or, a display of an ad is shown in display 472. As the underlying events for the map are done, the display 474 shows the map produced by the map application. In any case, this is one of the ad opportunities that can happen a lot on a mobile device every day.

The parameters at 434 define one of such opportunities, including when, where and how an ad will be displayed when such opportunity comes. At 436, the ad publisher sets up an initial fee for queuing an ad for the opportunity and auctions the opportunity among the advertisers of the ads identified at 432. The process 430 now goes to 438 and 440 to determine how many advertisers are interested in the spot. Specifically, at 438, the initial fee may be set too low, thus more than one advertisers hope to place their ads in that opportunity. If that happens, the process 430 goes to 442, where the fee is increased or incremented. At 438, the number of the interested advertisers is checked again. If the number is still greater than one, the process 430 goes on to increase the fee again till there is only one advertiser left. Likewise, at 440, the initial fee may be set too high, thus not a single advertiser wants to pay for opportunity. If that happens, the process 430 goes to 444, where the fee is decreased or decremented. At 440, the process 430 checks again to see if one interested advertiser wants to take this opportunity. If the number is still zero, the process 430 goes on to decrease the fee again till one advertiser takes the opportunity. In the end, either 438 or 440 identifies one advertiser interested in placing an ad in the opportunity.

The process 430 now goes to 446 to register an ad for the opportunity in a queue. In general, there are many ad opportunities a mobile device may present in a daily use. Each of the opportunities may be auctioned similarly. At 448, the process 430 checks to see if any remaining advertisers identified at 432 or any new advertisers have joined. If there are such advertisers, the process 430 goes to 434 to continue the bidding process. If there are no more advertisers, the process 430 goes to 450 to wait for an opportunity to come. FIG. 4D shows an example of lined-up ads for showing when an opportunity presents.

Referring now to FIG. 4E, it shows a display 480 of a group space named “Discussion Group” formed by a group of 3 users, user A, user B and user C, known to each other. Similar to Moments on WeChat or News Feed on Facebook, where users may not know each other but are all known to a user accessing thereto, a group space is specifically formed by users known to each other. Those skilled in the art that the description about the example posts shown in FIG. 1D, 2B.1 or 2D can be equally applied to a post made in a group space.

FIG. 4E shows three displays 480, 484 and 488 on a mobile device used by user A. The display 480 shows some messages being exchanged among the three users. In particular, user B posted an article to user A, but user C also received the post. It is assumed that user B has signed for the rewarded-viewing service. When user B tries to access the article, the data of the article is downloaded from a server providing the social media platform. The server executing the server module (e.g., the server module 402 of FIG. 4A) inserts an allocated ad into the article. Depending on a preference agreed upon by user B, an allocated ad 486 may be inserted at the beginning of the article or overlaid upon the article as shown in the display 484. The display 488 shows that the allocated ad 486 is inserted in the middle of the article or overlaid upon the article as shown in the display 488.

It is assumed that user C has not signed for the rewarded-viewing service. The post made in the group discussion can also be accessed by user C. When the post is clicked and accessed by user C, there would be no ads inserted in the article. In other words, the same post is accessed by two different users, one sees the allocated ads inserted by the server and the other one does not see an allocated ad.

As a search engine, Google (www.google.com) uses a bidding process among a plurality of advertisers for a limited number of advertising places, whenever these is a search inquiry from a user. Based on the payments, ads from winning advertisers are placed accordingly in the advertising places. It shall be noted that there are several significant differences between the bidding process offered by Google and the bidding process in the present invention. First, in Google case, the bidding process takes place when an ad opportunity is happening (per a search inquiry from a user). In the present invention, an opportunity is yet to happen. All advertisers are bidding for an opportunity that waits or scheduled to happen. Next, in Google case, the bidding process takes place when the advertisers have no idea who the user may be, all the advertisers are blindly bidding for an ad opportunity to show an ad to someone no who knows who may be looking at the ad, often resulting in showing an ad to someone with no interest at all. In the present invention, the advertisers know who will be looking at the ads. Based on the profile (e.g., employment or income level), the advertisers may even know if the user can afford, the likely chance their ads may be clicked through or a transaction may eventually happen. Even more, in Google case, an advertiser may have to pay a high price again and again for showing an ad to the same user when the user happens to perform repeatedly similar searches. In the present invention, as described above, when it is detected that the user does not do anything for a few ads in one category, the payout to the user for viewing the remaining ads in the category shall be automatically reduced, which in return could potentially save the advertising costs of these advertisers.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the description herein is largely on a user receiving a payment from a publisher or an advertiser for viewing an ad. In different embodiments, various vouchers, rewards, or discounts may be made as part of an incentive for the user to view the ad. Thus the payment described above shall also include other types of incentives for a user to view an ad. Further, the description herein is largely based on viewing an advertisement, those skilled in the art shall appreciate that the description is equally applicable to listening to an ad, an alert or a message. Accordingly, the scope of the present invention is defined by the appended claims rather than the foregoing description of embodiments.

We claim:

1. A method for accessing a post on a social media platform, the method comprising:
providing a social media platform supporting a post made by a first user using a first mobile device to at least a second user using a second mobile device, wherein the post includes a message embedded with at least a set of electronic code;
causing the second mobile device to display the code when the message is being accessed by the second user on the second mobile device;
receiving the code from the second mobile device after the second user uncovers the code from the message while accessing the message;
forwarding the code reported by the second user to the first mobile device for verification by the first user; and
settling a reward to an account maintained by the second user in the second mobile device when the first user confirms the code.

2. The method as recited in claim 1, wherein the post includes at least one of a text, a photo, an audio clip, a video clip and a hyperlink.

3. The method as recited in claim 2, further comprising: causing the second mobile device to display details of the post when the second user activates upon the post.

4. The method as recited in claim 3, wherein the post is electronically authored by the first user specifically for the second user, and the second user is instructed to access the post by uncovering the code and report the code to the first user.

5. The method as recited in claim 4, wherein a transaction is initiated by the first user to send the reward to the account of the second user.

6. The method as recited in claim 5, wherein the reward is at least one of cashes, points, electronic payments, discounts, and opportunities.

7. The method as recited in claim 1, further comprising:
receiving in a server the post from the first mobile device, wherein the server is provided to support the social media platform on which the first and second users exchange messages via a messaging channel; and
pushing the post by the server to the second mobile device via the messaging channel so that the post is only seen by the second user.

8. The method as recited in claim 7, further comprising:
causing the first and second mobile devices respectively to display an explicit advertisement bar, wherein an activation on the explicit advertisement bar brings up a category of advertisements, each of the advertisements indicates a pay rate to compensate the first user or second user for viewing one or more of the advertisements.

9. The method as recited in claim 8, wherein the explicit advertisement bar is inserted by an application programming interface (API) specifically designed to present the explicit advertisement bar on the social media platform.

10. The method as recited in claim 7, wherein the social media platform is one of WeChat and Facebook.

11. A method for accessing a post on a social media platform, the method comprising:
providing a social media platform supporting a post published by a first user using a first mobile device to a sharing space formed by a group of selected contacts of at least a second user using a second mobile device;
verifying whether the second user has opted in receiving advertisements matching interests expressed by the second user;
inserting one or more allocated advertisements in the post;
pushing the post to the second mobile device, wherein the post includes a message embedded with the one or more allocated advertisements; and
settling a reward to an account maintained by the second user in the second mobile device when the message is accessed by the second user.

12. The method as recited in claim 11, further comprising:
pushing the post received from the first mobile device to a third mobile device associated with a third user, wherein the post does not have an allocated advertisement when a server is configured to verifier that the third user has not opted in any advertisements in a post thereto.

13. A server for accessing a post on a social media, the server comprising:
a network interface to facilitate the server to communicate with a plurality of mobile devices;
a memory space for storing a server module;
a processor, coupled to the memory space, executing the server module to cause the server to perform operations of:
receiving a post made by a first user using a first mobile device for at least a second user using a second mobile device, wherein the post includes a message embedded with at least a set of electronic code;
causing the second mobile device to display the code when the message is being accessed by the second user on the second mobile device;
receiving the code from the second mobile device after the second user uncovers the code from the message while accessing the message;
forwarding the code reported by the second user to the first mobile device for verification by the first user; and
settling a reward to an account maintained by the second user in the second mobile device when the first user confirms the code.

14. The server as recited in claim 13, wherein the operation further comprises: causing the second mobile device to display details of the post when the second user activates upon the post.

15. The server as recited in claim 14, wherein the post is electronically authored by the first user specifically for the second user, and the second user is instructed to access the post by uncovering the code and report the code to the first user.

16. The server as recited in claim 15, wherein a transaction is initiated by the first user to send the reward to the account of the second user.

17. The server as recited in claim 13, wherein the operation further comprises:
causing the first and second mobile devices respectively to display an explicit advertisement bar, wherein an activation on the explicit advertisement bar brings up a category of advertisements, each of the advertisements indicates a pay rate to compensate the first user or second user for viewing one or more of the advertisements.
